(19) United States
(12) Patent Application Publication
(10) Pub. No.: US 2004/0120667 A1
(43) Pub. Date: Jun. 24, 2004

(54) Walled network optical component

(75) Inventors: Peter T. Aylward, Hilton, NY (US); Narasimharao Dontula, Rochester, NY (US); Richard D. Bomba, Rochester, NY (US); Thomas M. Smith, Spencerport, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/327,796

(22) Filed: Dec. 23, 2002

(51) Int. Cl. G02B 6/04; G02B 6/10

(52) U.S. Cl. 385/115; 385/146

(57) ABSTRACT

This invention relates to an optical light transmitting component including a network of cells containing filler material, the cells being walled on the sides and unwalled on the top and bottom portion of each cell, the walled sides comprising a polymer having a first refractive index, and the cells comprising a filler material having a second refractive index greater than the first refractive index, whereby light may be transmitted through the filler material and the unwalled top and bottom portion of the cells.

### FIELD OF THE INVENTION

This invention relates to an optical light transmitting component including a network of cells containing filler material, the cells being walled on the sides and unwalled on the top and bottom portion of each cell, the walled sides comprising a polymer having a first refractive index, and the cells comprising a filler material having a second refractive index greater than the first refractive index.

### BACKGROUND OF THE INVENTION

Video display screens are commonly used in television (TV) for example, and typically use cathode ray tubes (CRTs) for projecting the TV image. In the United States, the screen has a width to height ratio of 4:3 with 525 vertical lines of resolution. An electron beam is conventionally scanned both horizontally and vertically in the screen to form a number of picture elements, i.e. pixels, which collectively form the image. Color images are conventionally formed by selectively combining red, blue, and green pixels.

Conventional cathode ray tubes have a practical limit in size and are relatively deep to accommodate the required electron gun. Larger screen TVs are available, which typically include various forms of image projection against a suitable screen for increasing the screen image size. However, such screens have various shortcomings including limited viewing angle, limited resolution, and limited brightness and typically are also relatively deep and heavy.

Various configurations are being developed for larger screen TVs that are relatively thin in depth. These include the use of conventional fiber optic cables in various configurations for channeling the light image from a suitable source to a relatively large screen face. However, typical fiber optic thin projection screens are relatively complex and vary in levels of resolution and brightness.

When viewing any type of video display screen, image contrast is an important parameter that affects viewing quality. To achieve high contrast in all ambient lighting conditions, it is necessary that the viewing screen be as dark as possible. This enables the actual black portions of the image to appear black. The manufacturers of conventional television cathode ray tubes have been trying to develop screens which appear darker or blacker for improving picture quality. However, it is impossible for direct view CRTs to actually be black because they utilize phosphors for forming the viewing image, with the phosphors themselves not being black.

U.S. Pat. No. 5,625,736 discloses an optical display that includes a plurality of stacked optical waveguides having first and second opposite ends collectively defining an image input face and an image screen, respectively, with the screen being oblique to the input face. Each of the waveguides includes a transparent core bound by a cladding layer that has a lower index of refraction for effecting internal reflection of image light transmitted into the input face to project an image on the screen, with each of the cladding layers including a cladding cap integrally joined thereto at the waveguide second ends. Each of the cores are beveled at the waveguide light inlet side so that the cladding cap is viewable through the transparent core. Each of the cladding caps is black for absorbing external ambient light incident upon the screen for improving contrast of the image projected internally on the screen. The formation of this waveguide requires numerous manufacturing and assembling steps. There remains a need for an improved means of forming a waveguide.

U.S. Pat. No. 6,307,995 discloses a flat planar waveguide with a gradient refractive index within the core. The core material has an index of refraction which decreases as the distance from the central plane increases. The decrease in the index of refraction occurs gradually and continuously. While this disclosure provides an improved means to minimize problems with decrease in efficiency, performance, and quality resulting from the light loss from the discreet bounces that the light undergoes in the optical waveguides of step index cladding type, and reduces the deleterious effects of chromatic dispersion when using optical waveguides of step index cladding type, it is still required that thin layers of material be coated and then stacked and glued together. There is a large opportunity for problems in the selection of materials and during manufacturing when stacking many layers together. Problems such as dust and dirt as well as air bubbles can cause spot defects or poor layer to layer adhesion. There remains a need for improved materials and means of forming waveguides for rear projection applications.

Outside the area of waveguides, optical panel and rear projection display screens, various processes for bonding thermoplastic films to non-woven webs or other thermoplastic films as well as making formed three-dimensional films are known in the art. For example, the Raley U.S. Pat. No. 4,317,792 relates to a formed three-dimensional film and the method for making such a film. In addition, the Merz U.S. Pat. No. 4,995,930 relates to a method for laminating a non-woven material to a non-elastic film. In U.S. Pat. No. 6,303,208, it is disclosed an elastomeric breathable three-dimensional composite material and the process for producing the same. The three dimensional composite structure is formed through vacuum extrusion to make a plastic apertured film and is used for elastic breathable medical and hygiene applications. There is no mention of using the three-dimensional apertured for optical purposes. U.S. Pat. No. 6,255,236 relates generally to elastic laminates, and more particularly to a laminate having an elastic polymer film core with at least one layer of an extensible nonwoven web bonded to each side of the elastic polymer film core, and having one or more substantially inelastic, non-extensible regions located in the laminate. Furthermore U.S. Pat. No. 6,242,074 discloses a composite material having improved cloth-like texture and fluid transfer properties. In one embodiment, the composite material has a polymeric film with a plurality of apertured protuberances and a plurality of loose fibers coupled to the polymeric film, including at least a portion of the sidewalls of the protuberances. In another embodiment, the composite material has a polymeric film with first and second layers, a plurality of apertured protuberances extending through both layers, and a plurality of loose fibers coupled to the first layer and to at least a portion of the sidewalls of the protuberances. As noted in these patents, the use of a three-dimensional formed film has been used for a number of personal care and fluid retention. There remains a need for improved materials and means of forming waveguides for rear projection applications.

Accordingly, an improved thin or flat panel optical screen for use in a projection TV or large format display, for example, is desired.

In U.S. Pat. Nos. 6,120,026 and 5,254,388 it is disclosed a means of forming a directional viewing screen using micro louvered film with clear areas of a first coefficient of extinction separated by louvers and an outer region adjacent to the clear region having a second coefficient of extinction. The means of making the microlouvers involves the formation of a billet that is thermally fused together and then a thin veneer cut is removed from the billet. Other layers are then attached to the veneer cut film. Such a process to form a screen requires coextrusion of a multi layer film, punching, fusing, cutting, smoothing, laminating and coating. It is a long tedious and expensive means of making a screen. In addition U.S. Pat. No. Re. 27,617 (Olsen) teaches a process of making a louvered light control film by skiving a billet of alternating layers of plastic having relatively lower and relatively higher optical densities. Upon skiving the billet, the pigmented layers serve as louver elements, which, as illustrated in the patent, may extend orthogonally to the resulting louvered plastic film. U.S. Pat. No. 3,707,416 (Stevens) teaches a process whereby the louver elements may be canted with respect to the surface of the louvered plastic film to provide a film that transmits light in a direction other than perpendicular to the surface of the film. U.S. Pat. No. 3,919,559 (Stevens) teaches a process for attaining a gradual change in the angle of cant of successive louver elements.

### PROBLEM TO BE SOLVED BY THE INVENTION

There continues to be a need for improved optical elements such as those useful in a waveguide or privacy screen and simplified processes for making them.

### SUMMARY OF THE INVENTION

The invention provides an optical light transmitting component including a network of cells containing filler material, the cells being walled on the sides and unwalled on the top and bottom portion of each cell, the walled sides comprising a polymer having a first refractive index, and the cells comprising a filler material having a second refractive index greater than the first refractive index, whereby light may be transmitted through the filler material and the unwalled top and bottom portion of the cells. The invention also provides a process for preparing such a component and a display device including such a component.

### ADVANTAGEOUS EFFECT OF THE INVENTION

This invention provides a superior rear projection waveguide. and privacy screen. Specifically, it provides a waveguide and privacy screen that are simpler to manufacture

### BRIEF DESCRIPTION OF THE DRAWINGS

FIG. 1 depicts the top view of a walled network

FIG. 2 depicts a single cell of a multi-wall network with an open aperture

FIG. 3 depicts a single cell of a multi-wall network with transparent filler

FIG. 4 depicts a wall network with lenslet array on one side

FIG. 5 depicts a rectangular shaped network

FIG. 6 depicts a three-dimensional view of a walled network

FIG. 7 depicts a three-dimensional view of an individual walled cell

FIG. 8 depicts a microlouvered privacy screen

FIG. 9 depicts a stacked waveguide

### DETAILED DESCRIPTION OF THE INVENTION

As used herein, the following terms have the meanings designated::

“Aperture” shall mean an open area that allows light to pass through.

“Transparent” shall mean having a % transmission of from 80 to 100%.

“Clad” shall mean a clear layer adjacent to the transparent core of a waveguide.

“Clad cap” shall mean the black adhesive layer next to the clad layer

“Microlouver” shall refer to the linear section of a privacy screen that absorbs light and reduces off angle viewing in the plane approximately 90 degree to the microlouver directional alignment.

“Walled network” shall mean a series of joined three-dimensional cells of any shape and shall have at least one layer.

“Cell” shall mean an individual three-dimensional walled element having at least one wall.

“Open cell” or “aperture” shall mean the open area in the walled network that only contains ambient room gas such as air.

“Lenslet array” shall mean any non-planar shape or shapes that may be used to change the direction of light

The invention has numerous advantages over the prior art for making laminated stepped waveguides for display screens. The means of forming a laminated stepped waveguide as disclosed in U.S. Pat. Nos. 5,625,736; 6,002,826; and 6,307,995 involves coating at least 2 to 4 layers onto an optically clear film. The layers have a lower refractive index than the optically clear film plus an opaque adhesive clad cap layer. Methods of assembly involve slitting wide web into thin webs, chopping strips to a predetermined length and then stacking the strips one on top of the other and then fusing the layers together to form a screen. For a 50″ diagonal screen this might involve stacking and fusing several hundred or even thousands of strips. Other methods involve sheeting the coated film stacking and fusing the sheets in a block and then cutting a screen from the fused block of plastic. Various cutting methods may be used, but the process is very slow and usually results in an uneven surface that then needs to be ground and polished which can take hours or days. The grinding and polishing steps are very difficult and may result in scratches and digs into the surface of the plastic. The grinding and polishing steps also result in heat generation that can soften the adhesive between core layers and cause non-uniformities in the layer to layer interface. Another problem with stacked waveguides is that any thickness non-uniformities in the core film layer or the coating can result in an additive high or low spot when stacked on top of each other. The non-uniformity is magnified when pressure is applied to fuse the strips or sheets together. This can result in non-uniform pressure across the stack and therefore result in variable adhesion problems. Additionally in the formation of the stacked waveguide screens, it is necessary to have some depth to the screen. This may be in the order of 250 to over 500 mils in depth. This is required in order to provide a means of controlling ambient room light. As light from off angle enters the waveguide it is desirable to absorb the light in the black opaque layers. By providing adequate depth to the waveguide screen, some ambient light absorption is achieved.

Additionally in the formation of privacy screens there is also a need to provide adequate depth to the screen but in the order of 15 to 50 mils. The privacy screens have a microlouver feature that is physically similar to the clad and opaque layer of the stacked waveguides. The fundamental difference is that privacy screens have two layers with varying amounts of light absorbing material whose clear areas have a higher coefficient of extinction than the louvers while the waveguide has two layers one of which has a lower refractive index to provide total internal reflection of light that enters the waveguide within the critical angle and a second layer of black light absorbing material. In the formation of these privacy screens a multi-layer film with the desired layers is punched into a round disc and then stacked one on top of the other and then heat and pressure fused into a billet-like log. The billet is then veneer cut into sheets of the desired thickness. Subsequence functional layers are then either coated or laminated to the veneer cut sheet to form a privacy screen.

Manufacturing both laminated waveguides and privacy screens involve several steps including coating film, cutting, slitting, punching and fusing. Additional smoothing steps may also be required. It may also be necessary to laminated or coat other layers to the screens to provide improved viewing enhancements. By forming an interconnected walled network of polymer that has apertured cells in a one step vacuum extrusion or thermoforming process and then filling the open cells with a clear polymer material; a screen can be easily made. In either process more than one layer can be formed into a three-dimensional shape. The more desirable process is to provide at least two layers. In the case of a display screen the wall next to the open area is a clear polymer with a lower refractive index than that of the transparent filler polymer and the second wall is a black filled polymer that provides a high level of opacity. In the case of a privacy screen, there is a need for two layers of wall. The layer adjacent to the filled apertured has a lower coefficient of extinction and is usually filled with a low level of light absorbing material such as carbon black or dye. The second wall layer is a very opaque and is more highly filled with carbon black or dye than the first louver. In both cases the pre-formed wall network provides a mold that has the light reflecting or absorbing properties required for either the waveguide screen or privacy screen. By filling the open cells within the network, a usable screen is quickly formed. For privacy screens the network walls are thinner than those needed for rear projection screens. These and other advantages will be apparent from the detailed description below.

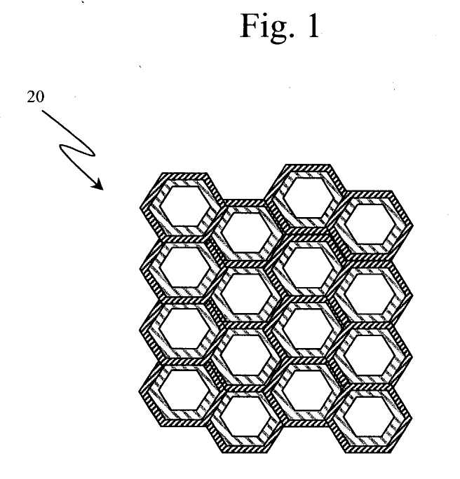

FIG. 1 depicts the top view of a walled network 20.

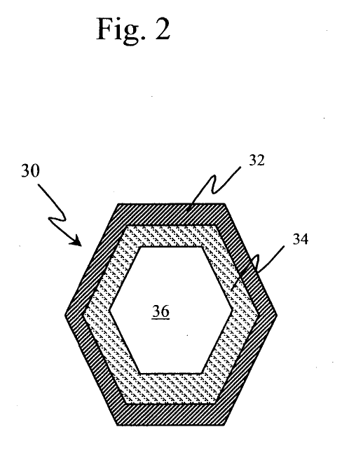

FIG. 2 depicts a single cell of a multi-wall network 30 that has an outer wall 32 that is a light absorbing wall of filled polymer and an inner wall 34 that is clear for a waveguide screen and lightly filled for a privacy screen and open aperture 36.

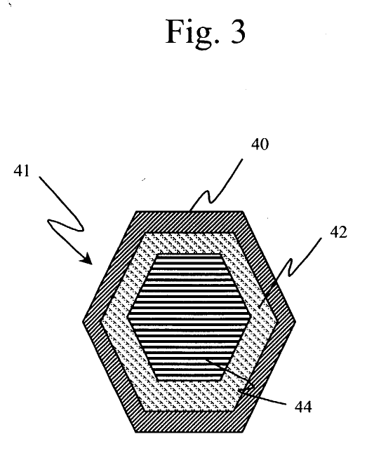

FIG. 3 depicts a single cell of a multi-wall network with transparent filler 41 that is made up of an outer wall 40 that is black and opaque and an inner wall 42 that is adjacent to transparent filled aperture 44. Inner wall 42 has a lower refractive index than the transparent filled aperture 44 for a waveguide but for a privacy screen inner wall 42 has a lower coefficient of extinction than transparent filled aperture 44. Typically the clear area has a coefficient of extinction that is at least 1.5 time that of the louver that is adjacent to the clear area.

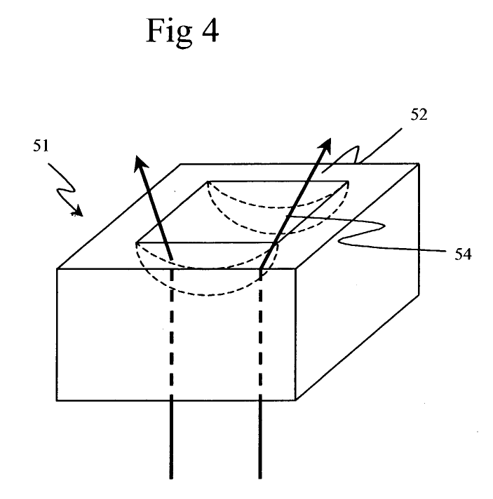

FIG. 4 depicts a wall network with lenslet array on one side 51 and is made up of transparent filled individual multi-wall cells 52 and lens array 54. Lens arrays may be on one or both sides of the network and may be either an integral part of the network or attached as a separate sheet.

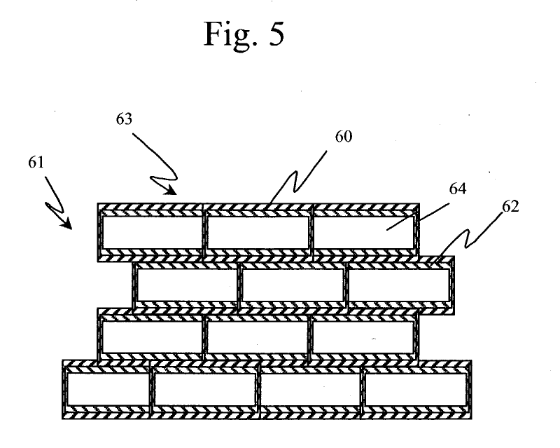

FIG. 5 depicts a rectangular shaped network 61 that is made from a series of individual cells 63 that comprise an outer wall 60, and inner wall 62 and filled aperture 64.

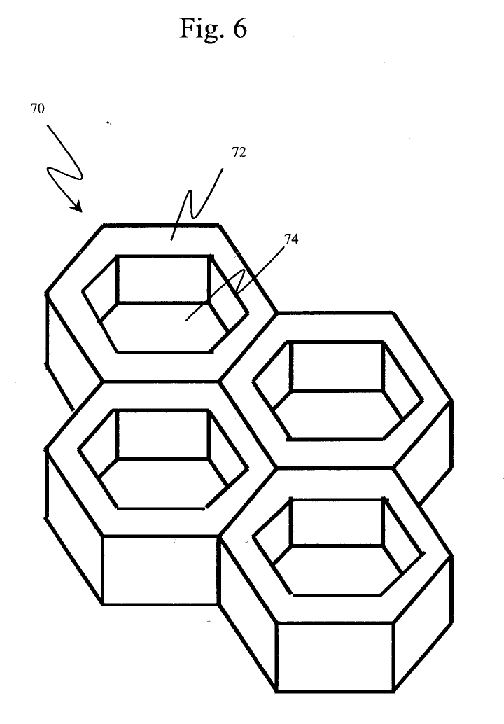

FIG. 6 provides a three-dimensional view of walled network 70 with wall 72 and open aperture 74.

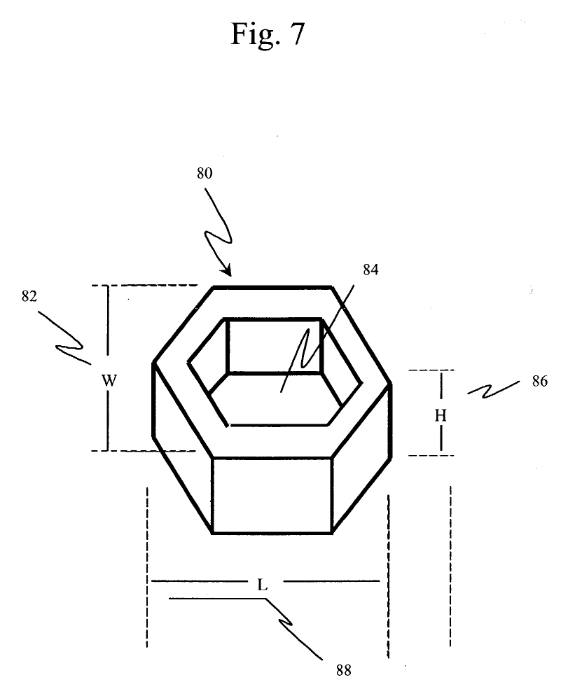

FIG. 7 provides a three-dimensional view of a single open apertured cell 80 with cell length distance 82, cell width 88 and cell depth 86.

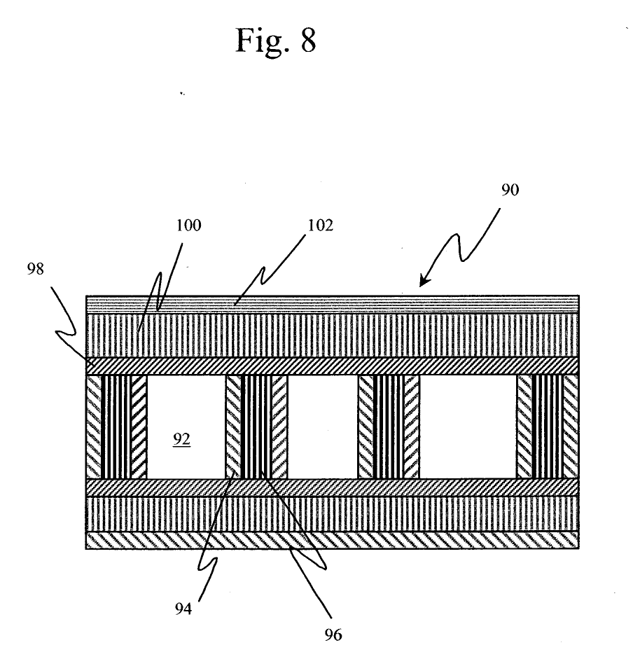

FIG. 8 depicts a privacy screen 90 which is formed using a heat fusion process in which a billet is made and then a veneer cut of film, approximately 10 mils thick, is shaved from the billet. The basic construction referred to herein is made up of transparent core 92, first coefficient of extinction layer 94 that contains a low level of light absorbing material such as carbon black and second layer 96 that is more highly filled with light absorbing material than layer 94. Fused veneer cut layers 92,94 and 96 are subsequently laminated with film 100 and is attached to the veneer cut film by adhesive layer 98. Coating layer 102 may be applied to layer 100 before or after lamination. Layer 94 and 96 form microlouvers that help to restrict the viewing angle.

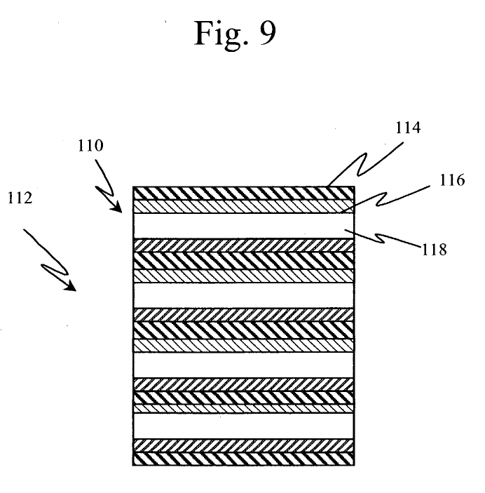

FIG. 9 depicts a stacked laminated waveguide 110 that is made up of multiple individual waveguides 112. Each individual waveguide is made from a transparent core 118 and clear clad layer 116 that has a lower refractive index than the transparent core and a opaque adhesive layer 114 that is used to hold the structure together and also to absorb ambient room light.

In an embodiment of this invention an optical component contains a walled network of filled cells comprising walls containing a polymer having a first refractive index and, bounded by the walls, a filler containing a material having a second refractive index. Such an optical component has many uses and has advantages over prior art material such as stacked waveguide. The wall network screens can be made in a couple of manufacturing steps. The basic framework of the network may be formed by vacuum extrusion or weaving fibers together to form an array of individual cells that form a three-dimensional network. The walled network can then be filled with a transparent core material. Such a construction may be used for a waveguide. It may also be used as a display screen with a light inlet and viewing surface. The walled network or woven fiber have a three-dimensional shape to them, which is useful to control or absorb ambient light. Ambient light can cause the projected image to appear “washed-out” and interferes with the viewing pleasure of the display. The prior art screens are formed by coating several layers of lower refractive index materials and adhesive on each side of a clear transparent polymer core such as polycarbonate or polymethyl methacrylate. The outer-most layers are typically opaque and have adhesive properties. Rolls are then either slit into thin ribbons or sheeted and subsequently stacked and fused together. To form a display screen for rear projection TV it requires several thousand layers be stacked and fused. This process has many problems and is very labor intensive. Furthermore the stacked laminated waveguide screens are typically structurally weak. This is avoided if the walled network described above is used to make the screen.

In an embodiment of this invention, the formation of the walled network optical components that can be used as a waveguide has one or more layers and a filled transparent core in which the first refractive index of the wall adjacent to the filled core is lower than the second refractive index of the filled core. Typically it is desirable to have a difference of between 0.005 and 0.2 refractive index units between first refractive index polymer and the second refractive index material. In order to waveguide light there needs to be a difference in refractive index between the core and the adjacent wall layer. Below 0.005 there is little or no value for waveguiding while differences greater than 0.2 have a very high acceptance angle of light entering the waveguide such that ambient light is projected back into the projection side of the screen. High acceptance can also result in viewing limitations of the screen. The most desirable range of refractive index difference between the first refractive index material and the second refractive index material is from 0.01 and 0.02. Above 0.02 requires more expensive polymers to achieve while below 0.01 have limited usefulness for totally reflecting light internal within the core of the waveguide.

While it is possible to build a three dimensional walled network with one layer in which the single wall is opaque and also has a lower refractive index than the filled core, it is desirable to have a network with at least one layer to improve the overall efficiency of the screen. With more than one layer it is possible to provide at least one clear layer of lower refractive index material and an opaque layer that is capable of absorbing light. Having a clear clad layer or lower refractive index material next to the filled core is more efficient for reflecting light back into the filled core. When the opaque layer is next to the filled core, there is some light loss due to scattering and therefore the overall efficiency of the optical component is reduced.

In the case of a multi-walled network the opaque wall may also be black. Black material such as dyes and pigments including carbon black may be used. Ideally it is desirable to have the black opaque layer with a percent transmission of zero but for most applications it is sufficient to have the opaque material with a percent transmission of from 1-30 percent. While below 1% transmission is achievable it become very costly to highly fill the polymer and if the particles of black material are not properly dispersed, large agglomeration may be formed that will cause light scattering. If the transmission percent is too high for the opaque wall, light may be transmitted through it into the next filled core. Typically transmission percents greater than 30 will result in some light leakage into other filled cores of the networks.

Materials that are useful in the construction of walled network include polyolefin, polyester, polyamide, polycarbonate, cellulose acetate and copolymers thereof.

In the formation of multi-walled networks it may be desirable to use different materials for each wall. This provides a broader selection of materials to obtain a difference in refractive index or other properties such as wetting of the wall and adhesion with said filler. Useful materials for the filler of the walled network should have a percent transmission of between 80 and 100%. Below 80 percent transmission tend to have lower optical clarity and therefore have lower overall optical efficiency. While 100% is the highest transmission that can be achieved, it is recognized that all material will absorb or scatter some small amount of light.

In one embodiment of this invention the walled network is formed with polyolefin. Polyolefins are desirable because they are easily formed into networks and the polymer is readily available. In another embodiment the wall network is made with polyester. Polyester is desirable because it is a tougher polymer and typically stiffer than other polymers. Improved stiffness is desirable in the final screen formation and may be less prone to screen sagging.

In other embodiments the walled network may be made with polycarbonate. Polycarbonate is a very tough polymer and is desirable when the screen is subjected to excessive physical abuse. nother material that may be useful in the formation of the walled network is polyamide. Polyamide is very tough yet resilient.

The optical component made from walled networks of filled cells may use a variety of filler materials. Useful transparent polymers may comprise polyester, acrylic, polyurethane, epoxy, cyclic olefinand cellulose esters. In one embodiment the filler is polyester. Polyesters typically have good optical clarity for the transmission of light. In another embodiment the filler may be acrylic. Acrylics are desirable because they can be formulated to flow easily into the walled network. They also have excellent optical clarity and are very hard and scratch resistant when hardened. They also can be formulated to be radiation curable. Since there is some volume associated with the filled networks, the use of radiation curable materials is desirable.. Polyurethane may also be used as a filler. Polyurethane is a very tough polymer and offers good optical clarity. In a preferred embodiment of this invention epoxy may be used as a filler for the walled network. Epoxies have a wide range of viscosities and can be formulate to provide excellent leveling. They can be to provide a broad range of refractive index. They can be cured with thermal or radiant energy and are very useful in that they can be used with walled networks that are bent into a contoured shape. Useful shapes may include planar and non-planar shapes. In one embodiment the shape may be curved. Such a shape may be useful for surround viewing in which the screens provide peripheral viewing in either the vertical and or horizontal planes. In the selection of the walled network it may be desirable to have a screen that is formed into a shape and fully hardened to freeze that shape or a flexible screen that could be bent and then returned to its original shape. Such screens would provide outstanding wear resistance and provide added versatility to the end user. The selection of the walled network and the filler material properties need to be considered when building the screen's end-use properties. When forming an optical component with a filled network, it is desirable to maximize the transparent area while minimizing the wall thickness. In an embodiment of this invention the transparent filled cells and network walls have a thickness ratio of between 30:1 and 3:1. Filled network walls above 30:1 tend to be very thin and weak and are difficult to form while filling. Network walls below 3:1 have limited viewing area and the wall structure is more visible. Useful network wall thickness for this invention may be from 10 to 750 micrometers. Below 10 micrometers it is difficult to vacuum form a network wall and it has very little strength. Above 750 micrometers the walls are very thick and are visible unless the screen is viewed from a very long distance.

Another aspect of the three-dimension network is the overall depth of the walled network. Useful depths may be between 100 and 8000 micrometers. When waveguiding light for a projection screen it is desirable to have a thickness equal to or greater than 100 micrometers. Below 100 micrometers, ambient light from viewing room sources or from sunlight may pass directly through the waveguide and not be absorbed by the black opaque layer. Additionally walled networks less than 100 micrometers tend to be very weak and flimsy. In optical components when the layer thickness is greater than 8000 micrometers, there are high light losses and therefore the overall operating efficiency is reduced.

Another useful embodiment of this invention is a network that is apertured. In the formation of the network wall structure, it is desirable to have an open or apertured area. Such an opening can be more readily filled with a transparent filler. Additionally it is desirable to have an apertured to walled network with a percent open area of between 65 and 95 percent on a projected basis. Below 65 percent open area, the network walls are visible and tend to interfere with the viewing of the screen while open areas greater than 95 percent have a weak wall that may tend to collapse when filling.

When making optical components with a walled network, it may also be desirable to provide a lenslet array on at least one side. Lenslet arrays may be useful in directing or shaping light on the inlet side or the viewing side of the component. On the viewing side the array may be used to improve the gain of a display screen in either or both the vertical or horizontal viewing planes. In one useful embodiment, the lenslet array is integral to the walled network of filled cells. When filling the network cells the lenslet array may be molded into the surface of the filled polymer or it may be embossed into the surface. An additional means is to preform a lenslet array and use a transparent adhesive material to not only fill the cells but to adhesively connect a sheet to the walled network light inlet and or viewing surfaces. In this embodiment the lenslet array may have different functions. The light inlet side may be a light directing or fresnel lens that can change the light direction and allow the light source to be placed in different locations. This is useful in making slim format projection screens in which the light is directed by a lens or mirror into the transparent filled cells from a sharp angle. The lens array provides a means of bringing the light into the transparent waveguide filled cell from a steep angle to a shallow angle. This helps to reduce the refractive difference between the filled cell and the adjacent clad layer of the walled network. On the viewing side it may be desirable to have a lenslet array provide diffusion of the light to improve the viewing gain of the system. In this way the horizontal and vertical-viewing angle may be controlled. In another embodiment the network of filled cells contains diffusion materials on at least one side. The diffusion material may be bulk diffusing or light shaping and furthermore the light shaping material may be holographic. Holographic made shapes may be designed and adjusted to control light in all angles and furthermore may help to reduce glare from ambient room light.

In another useful embodiment of this invention the lenslet array may be a crossed lenticular pattern. If two lenticular lens arrays are crossed at 90 degrees both vertical and horizontal viewing improvements may be made.

The lenslet arrays useful in this invention may be made with a transparent radiation curable material. Such materials may include UV monomers. UV-cured materials have excellent optical clarity and can be formed into a variety of shapes and are hardened by exposure to UV light and therefore avoids costly heat drying. UV and EB polymerization of acrylics and other materials are well known in the field of paints and surface coatings. The basic principles for either UV or EB are essentially the same. A material is cured by the irradiation of polymerizable mixtures of double-bonds containing oligomers, monomers, prepolymers, additives such as tackifiers, UV stabilizer, chain transfer agents, viscosity control or photoinitiators. In general there is a decomposition of photo-initiator into free radicals that reacts with molecules of monomer. The reaction continues with additional monomers in a propagation reaction. The reaction is terminated as polymeric molecules are formed by crosslinking. An advantage of EB curable over UV curable is that EB can cure through opaque materials.

UV curable materials typically are clear and can be applied to a substrate by most conventional coating methods known in the art. This coating contains a photo-initiator and when exposed to a source of UV radiation the polymerization process starts. Typical sources of UV energy include pressure mercury vapor lamps, iron-doped and gallium-doped spectral outputs or excimer UV lamps. The coating weight may be varied to optimize the properties.

The optical components made from a filled network of cells may have cells of a variety of shapes. A hexagonal shape is useful in that it provides a geometric design that allows for a very efficient packing of cells that helps to minimize any viewing obstructions form the walled network. Other useful shapes may be rectangular or circular in shape.

The walled network may be formed by a variety of means. One very useful means is to vacuum form the walled network by vacuum extrusion. Either a monolayer or multi walled network may be formed by melting the desired polymer and casting it onto a vacuum roll that contains the desired cell geometry. By applying vacuum to the shaped vacuum roller, the molten resin is formed around the shapes in the roller. When sufficient vacuum is applied an open or apertured cell is formed with a walled network. As the resin solidifies by cooling a polymeric network is formed. Another means of forming a walled network is to weave fiber or filaments into the desired shape and then fill the open areas with a transparent polymer. Instead of weaving it is possible to fuse by heat, ultrasonic and or pressure various strands of materials to form a walled network. A solid polymer sheet may also be formed into an open network of cells by punching or ablating holes through the sheet by mechanical or laser light. In another embodiment of this invention the network may be thermoformed. Thermoformed networks are made using a heat assisted process in which the network wall or cell structure are cast into a sheet and the sheet is them made to comply to a molded shape with the assistance of heat and/or pressure such as a vacuum. This type of process typically is a sheet process while the vacuum extrusion process may be either a continuous web or sheet process.

A process of forming a component providing a structure comprising network of filled cells comprising walls containing a polymer having a first refractive index and a filler containing a material having a second refractive index wherein said walled network is vacuum formed with at least one black layer and with apertured cells, placing said walled network over a lenslet array mold, filling said apertured cells and lenslet array mold with a transparent hardenable polymer, hardening said transparent hardenable polymer, removing said filled walled network with an integrally attached lenslet array from said lenslet array mold.

The optical component of this invention comprising a network of filled cells comprising walls containing a polymer having a first refractive index and a filler containing a material having a second refractive index further comprises a waveguide and in particular the optical component is a projection screen display. A process embodiment for forming the component of this invention provides a structure comprising a network of filled cells with walls containing a polymer having a first refractive index and a filler containing a material having a second refractive index wherein said walled network is vacuum formed with at least one black layer and with apertured cells, placing said walled network over a lenslet array mold, filling said apertured cells and lenslet array mold with a transparent hardenable polymer, hardening the transparent hardenable polymer and removing the filled network with integrally attached lenslet array from the mold, positioning the structure in front of a light directing film and projecting light through said light directing film and said filled vacuum formed walled network.

In a separate embodiment of this invention an optical component comprising a walled network of filled cells containing a polymer having a first coefficient of extinction and the adjacent wall containing a polymer having a second coefficient of extinction and also containing a filler material. By providing a transparent filler material in the open aperture of a wall network that has a coefficient of extinction different and higher than that of the adjacent wall of said wall network, it is possible to form a screen that can be used for privacy. The wall adjacent to the filler has a higher light absorbing capacity than the transparent filler and will therefore limit the viewing side of the screen. When the network cells are aligned with a somewhat linear pattern to the network, the viewability of the screen from the sides opposite to the linear pattern is reduced. Such screens are useful in tight seating situations in which the user desires to restrict others from seeing what is display. One example of this would be for computer screen that is used in public areas such as personal labtop computers. Other uses may be for games in which the intended user needs to restrict others from seeing his move or position.

The polymer of the second coefficient of extinction may also contain an opaque material that is light absorbing. The opaque material may be any color but in general black has more light absorbing properties. The black material may be a pigment, such as carbon black, or a black dye. Carbon black typically has better light absorbing properties than black dyes. The percent transmission of the polymer having the second coefficient of extinction may be between 0 and 20 percent. A material is fully absorbing at 0 percent transmission while materials greater than 20 percent transmission will not absorb as much light.

As discussed above the polymers for the walled network may be polyolefin, polyester, polyamide, polycarbonate and copolymers thereof. The thing to remember is that the wall of the walled network that is adjacent to the filler should have a lower coefficient of extinction than the transparent filler. This may be achieved in part by the selection and paring of the filler and the adjacent wall of the network or by the addition of materials to either or both the filler polymer or the polymer used to form the adjacent wall of the walled network. As with display screens discussed above, privacy screens may use a variety of transparent polymers for the filler. Typically it is desirable to have a percent transmission of between 80 and 100 percent to assure that there is good image quality on the viewing side of the screen. Typical polymers may include but are not necessarily limited to polyester, acrylic, polyurethane, and epoxy. When using a walled network those polymers that have a wide range of viscosity and can be flowed into the network's open aperture without air entrapment are the most desirable. Radiation curable polymer such as acrylates and chemically cured materials such as epoxies work the best. Although not disclosed in this discussion, the filler polymer may contain additives to improve the wetting of the walled surface to obtain better adhesion and minimize air entrapment. The surface energy of the wall network may also be adjusted to improve the wetting and adhesion at the interface between the filler polymer and the wall of the network.

In another embodiment of this invention the optical component used as a privacy screen may further contain a lenslet array to change the viewing angle of the screen. Typically for display screens that are used for rear projection TV or other display applications, it is desirable to provide a broad view angle. For privacy screens it is desirable to limit the viewing angle. This may also be accomplished by the addition of lenslet array shapes that narrow the viewing angle By collimating the light as it exits the privacy screens, it can be narrowed. Such collimating lenslets may be linear, triangular, pyramidal or other shape that provides light collimation.

Embodiments of the invention provide a process for making a waveguide or privacy screen that reduces the number of manufacturing steps and can be assembled without having to stack and adhere multiple layers together to form a screen.

The following examples illustrate the practice of this invention. They are not intended to be exhaustive of all possible variations of the invention. Parts and percentages are by weight unless otherwise indicated.

### EXAMPLES

### Example 1

The waveguide example was made from a preformed aperture single walled structure obtained from Tredegar Film Products Corporation of Richmond, Va. A small sample of the network film was cut and spray painted black to simulate a black absorbing layer. The sample was air dried and then sprayed with a clear acrylic thin layer to simulate a clear clad layer of a lower refractive index than the filler. The sample was allowed to dry. The multi layered open film was laid flat and then filled with a two-part epoxy and allowed to cure over-night to form a network.

### Example 2

This sample was made in a similar manner except part way through the epoxy drying process the network was bent into a curved shape to simulate a wrap around screen.

### Example 3

This sample was made the same as example one except the open apertured network was placed on top of a lens array. The epoxy was applied to the open aperture to fill the cells and to provide adhesion to the lens array.

### Example 4

This sample is a preformed multi walled apertured network formed by coextruding two layers of polyolefin onto a vacuum roll and applying a vacuum to form a two layer apertured cell. The wall adjacent to the aperture is a clear polymer while the other wall is a carbon filled polyolefin layer. The preformed film sheet is filled with a transparent polymer such as an epoxy.

### Example 5

This sample is the same as example 4 but a UV curable material is used to fill the aperture.

### Example 6

This sample is the same as example 1 except a UV curable material was used to fill the cells.

### Example 7

This waveguide example was made from a performed apertured single walled structure obtained from Tredegar Film Products Corporation of Richmond, Va. A small sample of the network film was cut and spray painted black to simulate a black absorbing layer. The sample was air dried and then sprayed with a diluted paint consisting of 1 part spray paint to 10 parts of solvent to simulate a layer of lower coefficient of extinction than the filler. The sample was allowed to dry. The multi layered open film was laid flat and then filled with a two-part epoxy and allowed to cure over-night to form a network..

Materials:

Epoxy:

The formulations suitably employ 1.00 parts of EPON 815 cross-linked with 0.48 parts of EPICURE 3373. Both materials are products of the Shell Chemical Company. EPON 815 is a bisphenol A/epichlorohydrin based resin and EPICURE 3373 is a cycloaliphatic amine. This mixture produced a clear, colorless, hard coating with good adhesion to walled networks. It also provides a low viscosity (<500 cps) which is important in minimizing entrapped air when filling a three-dimensional structure.

UV Curable:

NOA 81, manufactured by Norland Products Inc., was evaluated as a typical UV curable material. It is reported to be a mixture of mercapto esters with unsaturated acrylic, vinyl or allylic monomers, oligomers or prepolymers. Prior to curing it has a viscosity of 300 cps. In the cured state it has a refractive index of 1.56 and a Shore D hardness of 90. Coatings of this material were cured at an energy level of 4.9 J/cm².

Walled Network

This was an 82 mil thick three-dimensional apertured polyolefin film obtained from Tredegar Film Products Corporation of Richmond, Va.

The entire contents of the patents and other publications referred to in this specification are incorporated herein by reference.

### Parts List

20 is a top view of a walled network

30 is a single cell of a walled network with multiple walls

32 is the outer wall and is opaque and black

34 is the inner wall that is adjacent to the open aperture

36 is an open aperture of a single cell of a walled network

41 is a filled single cell of a walled network with multiple walls

40 is the outer wall and is opaque and black

42 is the inner wall that is adjacent to the filled apertured

44 is a transparent polymer filler in a single network walled cell

51 is a network wall with lenslets array

52 is the filled cell of the network

54 is a lens array

60 is an opaque clad cap layer and outer wall of the network

61 is a top view of a filled walled network

62 is the inner wall that is adjacent to the filled area of the cell

63 is a single element of the filled wall network consisting of a filled area 64, inner wall 62 and outer wall 60.

64 is a transparent filler

70 is a three-dimensional view of a walled network

72 is a three-dimensional wall of a wall network

74 is the three-dimensional open aperture

80 is a cell of a three-dimensional walled network showing relative dimensions

82 is the cell width

84 is the open aperture

86 is the cell depth

88 is the cell length

90 is a cross section of a privacy screen

92 is a clear polymer area of the privacy screen with a coefficient of extinction

94 is the first adjacent layer to the clear layer with a lower coefficient of extinction than the clear layer. It also contains a small amount of black material.

96 is a second layer with a higher level of black material than 94

98 is an adhesive layer

100 is a clear film to add strength to the structure

102 is an anti-glare layer

110 is a stacked waveguide made of several stacked individual units 112

112 is a single waveguide with core 118, clear clad 116 and clad cap 114

114 is a clad cap that is black and opaque

116 is a clear clad and has a lower refractive index than core 118

118 is a transparent polymer core

What is claimed is:

1. An optical light transmitting component including a network of cells containing filler material, the cells being walled on the sides and unwalled on the top and bottom portion of each cell, the walled sides comprising a polymer having a first refractive index, and the cells comprising a filler material having a second refractive index greater than the first refractive index, whereby light may be transmitted through the filler material and the unwalled top and bottom portion of the cells.

2. The component of claim 1 wherein said second refractive index is at least 0.005 greater than the first refractive index.

3. The component of claim 1 wherein said first refractive index and said second refractive index have a difference of from 0.005 to 0.20.

4. The component of claim 1 wherein said network comprises at least one layer.

5. The component of claim 1 wherein said network further comprises opaque material between cells.

6. The component of claim 1 wherein said walls comprise polyolefin.

7. The component of claim 1 wherein said walls comprise polyester.

8. The component of claim 1 wherein said walls comprise polyamide.

9. The component of claim 1 wherein said walls comprise polycarbonate.

10. The component of claim 1 wherein said filler material comprises a transparent polymer.

11. The component of claim 10 wherein said transparent polymer further comprises at least one material selected from the group consisting of polyester, acrylic, polyurethane, epoxy, cyclic olefin, and cellulose ester repeating units.

12. The component of claim 11 wherein said transparent polymer comprises an acrylic repeating unit.

13. The component of claim 11 wherein said transparent polymer comprises a polyurethane repeating unit.

14. The component of claim 11 wherein said transparent polymer further comprises an epoxy repeating unit.

15. The component of claim 10 wherein said transparent polymer comprises a radiation curable material.

16. The component of claim 10 wherein said transparent polymer comprises a chemically cross-linked material.

17. The component of claim 10 wherein said transparent polymer comprises a cyclic polyolefin.

18. The component of claim 1 wherein the ratio of the width of the filled cell to the average cell wall thickness is from 30:1 to 3:1.

19. The component of claim 1 wherein said network has an average cell wall thickness of from 10 to 750 micrometers.

20. The component of claim 1 wherein said network has an average depth from top to bottom of from 100 to 8000 micrometers.

21. The component of claim 1 wherein the transparent polymer filler area to total walled cell area is 65 to 95 on a projected area basis.

22. The component of claim 1 comprising a network of filled cells that further comprise a lenslet array on at least one side.

23. The component of claim 22 wherein said lenslet array is integral to the walled network of filled cells.

24. The component of claim 22 wherein said lenslet array comprises a transparent UV curable polymer

25. The component of claim 22 wherein said lenslet array is on two sides of the walled network of filled cells.

26. The component of claim 1 comprising a network of filled cells further comprising a light directing material on the top or bottom of the network.

27. The component of claim 1 wherein said network of filled cells comprises cells having a hexagonal shape.

28. The component of claim 1 wherein said network of filled cells comprises cells having a rectangular shape.

29. The component of claim 1 wherein said network of filled cells comprises cells having a circular shape.

30. The component of claim 1 wherein said network is woven.

31. The component of claim 1 wherein said network of filled cells exhibits a non-planar shape.

32. The component of claim 1 wherein said network of filled cells exhibits a curved shape.

33. A process of forming a component comprising providing a network of cells containing filler material, the cells being walled on the sides and unwalled on the top and bottom portion of each cell, the walled sides comprising a polymer having a first refractive index, and the cells comprising a filler material having a second refractive index greater than the first refractive index, whereby light may be transmitted through the filler material and the unwalled top and bottom portion of the cells, wherein
said walled network is vacuum formed with at least one black layer and with unfilled cells;
placing said walled network over a lenslet array mold;
filling said unfilled cells and lenslet array mold with a transparent hardenable polymer;
hardening said transparent hardenable polymer and removing the filled network with integral attached lenslet array from the mold;
positioning said structure in front of a light directing film.

34. A component comprising a walled network of filled cells comprising walls wherein said filler comprises a transparent polymer having a first coefficient of extinction and wherein said walled network comprises at least two layers wherein the adjacent wall to the transparent polymer comprises a polymer having a second coefficient of extinction.

35. A component of claim 34 wherein said walled network of filled cells further comprises a privacy screen.

36. The component of claim 34 wherein said polymer having a first coefficient of extinction further comprises an opaque material.

37. The component of claim 36 wherein said opaque material is carbon black.

38. The component of claim 34 wherein said polymer having a second coefficient of extinction has a percent transmission of from 0 to 20 percent.

39. The component of claim 34 wherein said walled network comprises at least one material selected from the group consisting of polyolefin, polyester, and copolymers thereof.

40. The component of claim 34 wherein the filler material comprises acrylates, epoxy, and copolymers thereof.

41. The component of claim 34 wherein said polymer having a first coefficient of extinction has a percent transmission of from 80 to 100 percent.

42. The component of claim 34 further comprising a collimating lenslet array on the viewing side of the component.

43. A display device comprising the optical component of claim 1.

44. A waveguide comprising the optical component of claim 1.

45. A privacy screen comprising the optical component of claim 1.
